(19) United States
(12) Patent Application Publication
(10) Pub. No.: US 2005/0145692 A1
(43) Pub. Date: Jul. 7, 2005

(54) Vending machine

(75) Inventor: Kuniyuki Tokizawa, Isesaki-shi (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 11/024,752

(22) Filed: Dec. 30, 2004

(30) Foreign Application Priority Data
Jan. 5, 2004 (JP) 000326/2004

(51) Int. Cl. G06F 7/08

(52) U.S. Cl. 235/381

(57) ABSTRACT

A vending machine which can communicate with a host computer by establishing dial-up connection to a predetermined access point, includes a control device which issues an inquiry to a communication device about all or a part of necessary information for dial-up connection, and establishes dial-up connection according to the information received from the communication device.

### BACKGROUND OF THE INVENTION

1. Field of the Invention

The present invention relates to a vending machine capable of communicating with a host computer, and more specifically to the technology of a setting method required for the communications with a host computer.

2. Description of the Related Art

A vending machine of this type is known that is disclosed in Japanese Patent Publication No. 10-63926. The vending machine has a built-in communication device such as a modem for connection to a host computer. The type of communication device is selected depending on the style of connection to a host computer. A vending machine mounted outdoor frequently uses a communication device for wireless connection to a host computer.

A communication device for wireless communication can be a terminal in accordance with the PDC (Personal Digital Cellular), PHS (Personal Handyphone System), GSM (Global System for Mobile Communications), or CDMA (Code Division Multiple Access) standards. The terminals of the communication devices of these types are assigned in advance telephone numbers by a carrier because these communication devices use a mobile communication network. The host computer can communicate with a vending machine by a packet communication system or a circuit switching system. When a packet communication system is used, a carrier assigns a predetermined address to each communication device. In the control device of a vending machine, a setting for dial-up connection is made in advance according to various information including a telephone number of a predetermined access point, an address of a communication device, etc., thereby allowing the vending machine to communicate with the host computer.

As describe above, it is necessary to set in advance an address of a communication device, etc. to make dial-up connection between a vending machine and a host computer over a mobile communication network. However, since a different address is assigned to each communication device, the setting operation is to be performed on each vending machine, and has been a very bothersome operation. Furthermore, after mounting a vending machine in the market, it is also necessary to make an additional bothersome setting operation when an address is updated by an exchange of the communications device.

### SUMMARY OF THE INVENTION

The present invention aims at providing a vending machine capable of easily making settings for communications.

To attain the advantage of the present invention, the present application proposes a vending machine capable of communicating with a host computer by dial-up connection to a predetermined access point including a communication device for dial-up connection, and a control device for setting dial-up connection according to information received from the communication device by making an inquiry about all or a part of necessary information for dial-up connection to the communication device.

According to the present invention, the control device obtains from the communication device all or a part of the necessary information for dial-up connection, and sets dial-up connection according to the information. Therefore, it is not necessary to perform different setting operations for each communication device. Therefore, the initial setting at the shipment from the manufactory and a change in setting after the shipment can be easily performed.

As a practical aspect of the present invention, the present application proposes the vending machine in which the communication device is assigned a predetermined telephone number in advance, and has storage device for storing a list describing a correspondence between a telephone number and an address, the control device issues to the communication device an inquiry about a telephone number assigned to the communication device, retrieves from the list an address corresponding to the telephone number received from the communication device, and sets dial-up connection using the retrieved address as an assigned address.

According to the present invention, if a list describing the correspondence between the telephone numbers and the addresses, of a plurality of communication devices is stored in a storage device in advance, it is not necessary to set different settings for a plurality of vending machines. Therefore, the initial settings at the shipment from a manufactory and a setting change after the shipment can be easily performed.

There can be a case in which a list stored in the storage device is to be updated after the shipment of the vending machine. Therefore, preferably an interface allowing a removable mobile storage medium can be attached to the vending machine, and the storage device can store the list from a mobile storage medium connected to the interface. Furthermore, the list can be received from the host computer, and the list can be stored in the storage device.

Other purposes, configurations, and effects of the present invention are clearly described below in detail.

### BRIEF DESCRIPTION OF THE DRAWINGS

FIG. 1 shows a network of the vending machine management system;

FIG. 2 is a block diagram of the control system of the vending machine;

FIG. 3 shows an example of a correspondence list;

FIG. 4 shows an example of a correspondence list; and

FIG. 5 is a sequential chart for explanation of the flow of setting dial-up connection.

### DESCRIPTION OF THE PREFERRED EMBODIMENTS

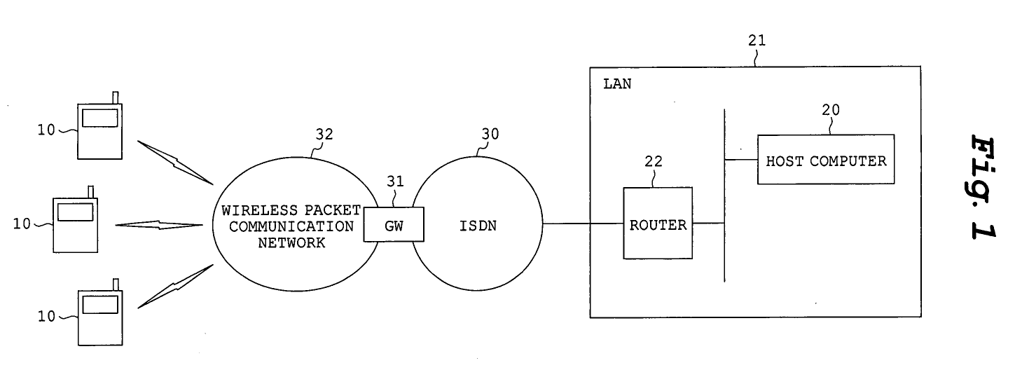

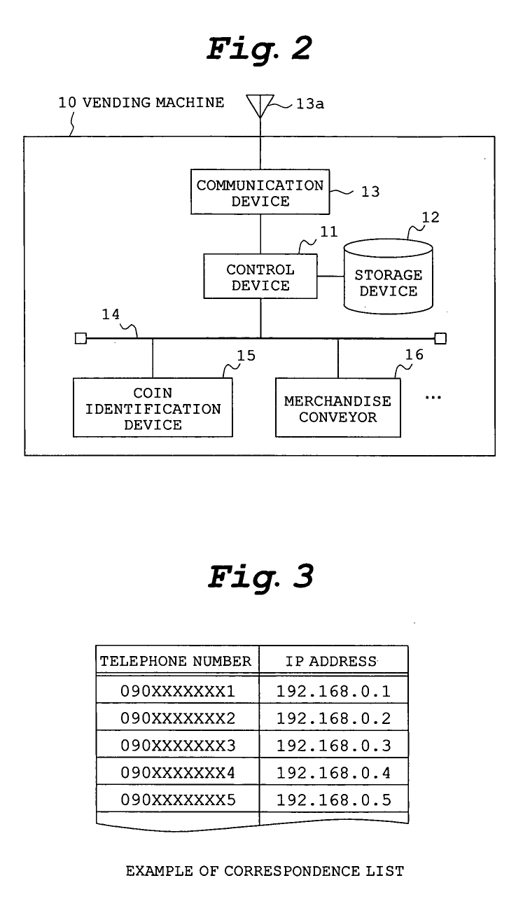

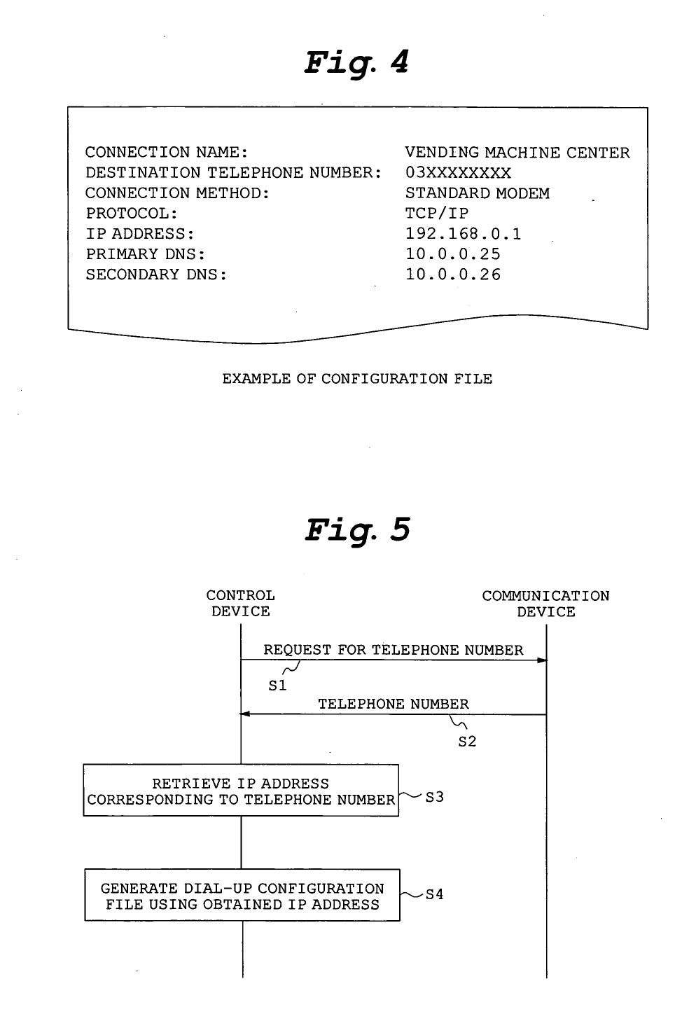

A vending machine according to an embodiment of the present invention is explained below by referring to FIGS. 1 to 4. FIG. 1 shows a network of the vending machine management system. FIG. 2 is a block diagram of the control system of the vending machine. FIG. 3 shows an example of a correspondence list. FIG. 4 shows an example of a configuration file. FIG. 5 is a sequence chart for explanation of the flow of setting dial-up connection.

In the vending machine management system according to an embodiment of the present invention, a host computer 20 centrally manages a plurality of vending machines 10 over a network as shown in FIG. 1. The host computer 20 is accommodated in a LAN (Local Area Network) 21 mounted for an administrator. The LAN 21 is connected to an ISDN (Integrated Services Digital Network) 30 through a router 22 which is a relay device. The ISDN 30 is connected to a wireless packet communication network 32 through a gateway 31 which is a relay device. Each vending machine 10 is provided with a communication device (not shown in FIG. 1) accommodated in the wireless packet communication network 32. With the above-mentioned network configuration, each vending machine 10 can be communicated with the host computer 20.

According to the present embodiment, the wireless packet communication network 32 is configured in a mobile communication network according to the PDC standards. A communication device connected to the wireless packet communication network 32 is assigned a telephone number by a carrier as an identification number for unique identification in the mobile communication network. In the present embodiment, a TCP/IP (Transmission Control Protocol/Internet Protocol) protocol suite is used as a protocol in the wireless packet communication network 32. A specific IP address is assigned by a carrier to a communication device connected to the wireless packet communication network 32. The IP address of a communication device is fixed because there is a case in which connection can be established from the host computer 20 to the vending machine 10.

The vending machine 10 comprises a control device 11, a storage device 12, and a communication device 13 as shown in FIG. 2. The control device 11 is connected to controlled equipment such as a coin identification device 15, a merchandise conveyor 16, etc. through a bus 14. In FIG. 2, only the above-mentioned two devices are illustrated as controlled equipment for simple explanation.

The control device 11 performs a merchandise sales operation to a consumer and a sales management operation, etc. for an administrator by controlling controlled equipment such as the coin identification device 15, the merchandise conveyor 16, etc. Since the controlling operation is the same as in the conventional technology, the explanation is omitted here. The storage device 12 functions as a storage area of the control device 11. The storage device 12 stores various data such as a correspondence list between a telephone number of a communication device and an IP address, a configuration file of dial-up connection, etc. According to the present embodiment, a personal computer is used as the control device 11, and a hard disk of the personal computer is used as the storage device 12.

The communication device 13 is a terminal for possible connection to the wireless packet communication network 32, and supports the TCP/IP and PPP (point to point protocol) as an available protocol. The communication device 13 supports an AT command as a command system. Especially, as an extended AT command, the communication device 13 supports a command to return a telephone number assigned to the communication device 13 at a request from the control device 11. The communication device 13 is, as described above, assigned a telephone number and an IP address by the carrier. An antenna 13a is connected to the communication device 13.

FIG. 3 shows an example of a correspondence list stored in the storage device 12. The correspondence list describes a plurality of correspondences between a telephone number and an IP address assigned to the communication device 13. The communication devices 13 to be listed include not only the above-mentioned communication device 13 itself but also all or a part of the communication devices 13 of the vending machines 10 that are managed by the host computer 20. As necessary, information about a standby communication device 13 not yet implemented to the vending machine 10 can be included. That is, the list includes the information about the communication device 13 to be managed and appropriately selected as required by the administrator of the vending machine 10.

FIG. 4 shows an example of a configuration file stored in the storage device 12. The configuration file is referred to when the control device 11 establishes dial-up connection for a predetermined access point using the communication device 13. That is, the control device 11 establishes connection by issuing a call to an access point based on the configuration file, and performs a process of setting an IP address. In the present embodiment, a PPP is used as a protocol of dial-up connection.

A set item included in the configuration file can be, as shown in FIG. 4, a “connection name” for unique identification of connection setting, a “destination telephone number” which is the telephone number of an access point, a “connecting method” for determining which communication device is to be used, an available “protocol”, an assigned “IP address”, an IP address of a “primary DNS (Domain Name System)” server, an IP address of a “secondary DNS” server, etc. The items other than the assigned IP address are common among a plurality of vending machines 10 to be managed. On the other hand, since the assigned IP address item is uniquely assigned to the communication device 13, it depends on each vending machine 10. The present invention aims at easily setting the assigned IP address.

An access point is the router 22 in the example of the configuration shown in FIG. 1, but the configuration can be designed such that communication equipment such as a TA (Terminal Adapter), etc. directly connected to the host computer 20 can be used.

Next, the operation of the vending machine according to the present embodiment is explained by referring to the sequence chart shown in FIG. 5. In FIG. 5, only the operations performed when the control device 11 sets dial-up connection are explained.

The control device 11 first issues to the communication device 13 an inquiry about the telephone number of the communication device 13 (step S1). In the present embodiment, an AT command is used in the inquiry. To be more practical, an “AT & P” command is issued to the communication device 13. The communication device 13 returns its own telephone number to the control device 11 in response to the inquiry (step S2). The telephone number is returned to the control device 11 in the format “ID=090XXXXXXX1”.

The control device 11 retrieves an IP address corresponding to the communication device 13 from the corresponding list in the storage device 12 by using the obtained telephone number (step S3). Using the obtained IP address, a configuration file of the storage device 12 is generated (step S4). Practically, the obtained IP address is set in the item of “IP address” shown in FIG. 4. In the above-mentioned operation, since the setting operation for dial-up connection of the control device 11 is completed, the control device 11 can establish dial-up connection to a predetermined access point. Therefore, the control device 11 can communicate with the host computer 20 as necessary.

As described above, according to the vending machine 10 of the present embodiment, appropriate dial-up connection can be set only by allowing a plurality of vending machines 10 to store a common correspondence list. That is, since it is not necessary to make a different setting for each vending machine, the bothersome operation can be reduced.

It is considered that the correspondence list between the telephone number and the IP address is to be changed after the shipment of the vending machine. For example, it is necessary when a new communication device is purchased as a standby device, when an IP address assigned by a carrier is to be changed, etc.

The method for easily updating the correspondence list can be providing for the control device 11 an interface to which a removable mobile storage medium can be attached. The mobile storage medium can be a flexible disk, a non-volatile memory card, etc. Then, a new correspondence list is recorded on the mobile storage medium. When the mobile storage medium is attached to the interface, the control device 11 overwrites the correspondence list stored in the record medium on the storage device 12.

Another method for easily updating a correspondence list is managing a new correspondence list in the host computer 20, reading the correspondence list when the control device 11 accesses the host computer 20, and overwriting the storage device 12. In this case, the update date of the correspondence list managed by the host computer 20 is compared with the update date of the correspondence list stored in the storage device 12. If the date managed by the host computer 20 is newer, the overwriting copy is performed. The update date can be periodically conformed, each time connection to the host computer 20 is performed, only when an instruction of the operator of the vending machine 10 is issued, or at an instruction from the host computer 20.

As described above, the present invention is described by referring to an embodiment of the present invention. However, the present invention is not limited to this application. That is, in the above-mentioned configuration, the control device 11 and the storage device 12 is realized by a personal computer, but another device can also be used in realizing it.

The protocol and the command system are only examples in the present embodiment, and other protocol, etc. can be used in embodying the present invention.

In the above-mentioned embodiment, the vending machine 10 is connected to the host computer 20 over the wireless packet communication network 32, but the present invention can be embodied by another network configuration. That is, the present invention can be embodied with a network configuration in which a communication device having the function of returning all or a part of necessary information for dial-up connection in response to an inquiry is used. Therefore, the packet communication system or the circuit switching system can be accepted, and any standards of wireless communication (PDC, PHS, GSM, CDMA, etc.) are accepted. Furthermore, either wireless communication or cable communication can be used.

In the above-mentioned embodiment, the router 22 mounted in the LAN 21 of the administrator is used as an access point to establish direct dial-up connection to the LAN 21. However, access from another path can be gained. For example, as described above, the communication equipment such as a TA directly connected to the host computer 20 can be an access point. Additionally, for example, communication equipment supplied by an Internet connection provider can be an access point. In this case, the communication path is used with the Internet.

1. A vending machine capable of communicating with a host computer by dial-up connection to a predetermined access point, comprising:
a communication device for dial-up connection; and
a control device for setting dial-up connection according to information received from the communication device by making an inquiry about all or a part of necessary information for dial-up connection to the communication device.

2. The vending machine according to claim 1, wherein
the communication device is assigned a predetermined telephone number in advance;
a storage device is provided for storing a list describing a correspondence between a telephone number and an address of the communication device;
the control device issues to the communication device an inquiry about a telephone number assigned to the communication device, retrieves from the list an address corresponding to the telephone number received from the communication device, and sets dial-up connection using the retrieved address as an assigned address.

3. The vending machine according to claim 1, wherein
an AT command is used in obtaining information from the communication device.

4. The vending machine according to claim 1, wherein
the control device sets dial-up connection by generating a predetermined configuration file, and establishes dial-up connection using the configuration file.

5. The vending machine according to claim 2, further comprising
an interface to which a removable mobile storage medium can be attached, wherein
the control device stores in the storage device the list from the mobile storage medium connected to the interface.

6. The vending machine according to claim 2, wherein
the control device receives the list from the host computer, and stores the list in the storage device.
